(19) United States
(12) Patent Application Publication
(10) Pub. No.: US 2022/0010869 A1
(43) Pub. Date: Jan. 13, 2022

(54) LIMITED SLIP DIFFERENTIAL ASSEMBLY WITH CLUTCH PACK PRELOAD SPRING DISPOSED BETWEEN SIDE GEAR AND DIFFERENTIAL PINION SHAFT MEMBER

(71) Applicant: American Axle & Manufacturing, Inc., Detroit, MI (US)

(72) Inventors: Eric KOUSAIE, Rochester Hills, MI (US); Brian MCCORMICK, Bloomfield Township, MI (US); Jacob GROBBEL, Macomb, MI (US)

(21) Appl. No.: 17/358,061

(22) Filed: Jun. 25, 2021

Related U.S. Application Data
(60) Provisional application No. 63/051,165, filed on Jul. 13, 2020.

(51) Int. Cl. F16H 48/22; F16H 48/08; F16H 48/40

(52) U.S. Cl. CPC F16H 48/22; F16H 48/08; F16H 2048/387; F16H 2048/085; F16H 48/40

(57) ABSTRACT

A differential assembly having a differential case, a differential gearset, a clutch pack and a preload spring. The differential gearset is received in the case and has a side gear and one or more differential pinion shaft members onto which differential pinions are rotatably mounted. The clutch pack is received in the differential case and has a plurality of first clutch plates, which are axially slidably but non-rotatably coupled to the differential case, and a plurality of second clutch plates that are interleaved with the first clutch plates and axially slidably but non-rotatably coupled to the side gear. The preload spring abuts the one or more differential pinion shaft members and the side gear and biases the side gear away from the one or more differential pinion shaft members to preload the clutch pack.

### CROSS-REFERENCE TO RELATED APPLICATIONS

This application claims the benefit of U.S. Provisional Application No. 63/051,165 filed Jul. 13, 2020, the disclosure of which is incorporated by reference as if fully set forth in detail herein.

### FIELD

The present application relates to a limited slip differential assembly with a clutch pack preload spring that is disposed between a side gear and a differential pinon shaft member.

### BACKGROUND

Limited slip differential assemblies having one or more clutch packs that are preloaded with one or more preload springs are known in the art. Commonly, such limited slip differential assemblies employ preload springs that are disposed between an interior wall of a differential case and a clutch pack and are configured to bias the clutch pack toward a respective side gear. During operation, torque transmitted from the differential pinions to the side gear tends to urge the side gear outwardly away from the differential pinions, thereby undesirably lessening to some degree the area of the teeth of the differential pinions and the side gear that are in mesh with one another.

It is known to employ one or more springs between the side gears of a limited slip differential assembly to bias the side gears apart from one another and to preload a pair of clutch packs. However, the known configurations can require excess components to handle relative rotation between the preload spring and one or more of the side gears, and/or can be somewhat difficult to assemble.

### SUMMARY

This section provides a general summary of the disclosure, and is not a comprehensive disclosure of its full scope or all of its features.

In one form, the present disclosure provides a differential assembly having a differential case, which is rotatable about a differential axis, a differential gearset, a first clutch pack and a first preload spring. The differential gearset received in the case and has a plurality of differential pinions, first and second side gears, and one or more differential pinion shaft members. Each of the first and second side gears is rotatable about the differential axis relative to the differential case and is meshingly engaged with the differential pinions. The one or more differential pinion shaft members couple the differential pinions to the differential case for common rotation about the differential axis. The one or more differential pinion shaft members support each of the differential pinions for rotation about a respective differential pinion axis that is perpendicular to the differential axis. The first clutch pack is received in the differential case and has a plurality of first clutch plates, which are axially slidably but non-rotatably coupled to the differential case, and a plurality of second clutch plates that are interleaved with the first clutch plates and axially slidably but non-rotatably coupled to the first side gear. The first preload spring abuts the one or more differential pinion shaft members and the first side gear. The first preload spring biases the first side gear away from the one or more differential pinion shaft members to preload the first clutch pack.

In another form, the present disclosure provides a differential assembly that includes a differential case, one or more pins, a plurality of differential pinions, a pair of side gears, a pair of clutch packs and a pair of preload springs. The differential case is rotatable about a differential axis and has first and second case members that each define a flange and an interior shoulder. Each of the flanges defines a plurality of pin recesses. The first and second case members are assembled to one another such that the flanges abut one another and the pin recesses form respective pin bores. The one or more pins received in the pin bores. The differential pinions are rotatably mounted on the one or more pins. Each of the side gears is meshingly engaged to the differential pinions and is rotatable about the differential axis. Each of the clutch packs is disposed between an associated one of the shoulders and an associated one of the side gears and has a set of first clutch plates, which are axially slidably but non-rotatably coupled to the differential case, and a set of second clutch plates that are interleaved with the first clutch plates and which are axially slidably but non-rotatably coupled to the associated one of the side gears. Each of the preload springs is mounted on a corresponding one of the side gears and comprising a Belleville spring washer that is disposed axially between the plurality of pins and the corresponding one of the side gears.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary differential assembly constructed in accordance with the teachings of the present disclosure;

FIGS. 2 and 3 are exploded perspective views of the differential assembly of FIG. 1;

FIG. 4 is a side elevation view of the differential assembly of FIG. 1;

FIG. 5 is a section view taken along the line 5-5 of FIG. 4; and

FIG. 6 is a section view taken along the line 6-6 of FIG. 4.

Corresponding reference numerals indicate corresponding parts throughout the several views of the drawings.

### DETAILED DESCRIPTION

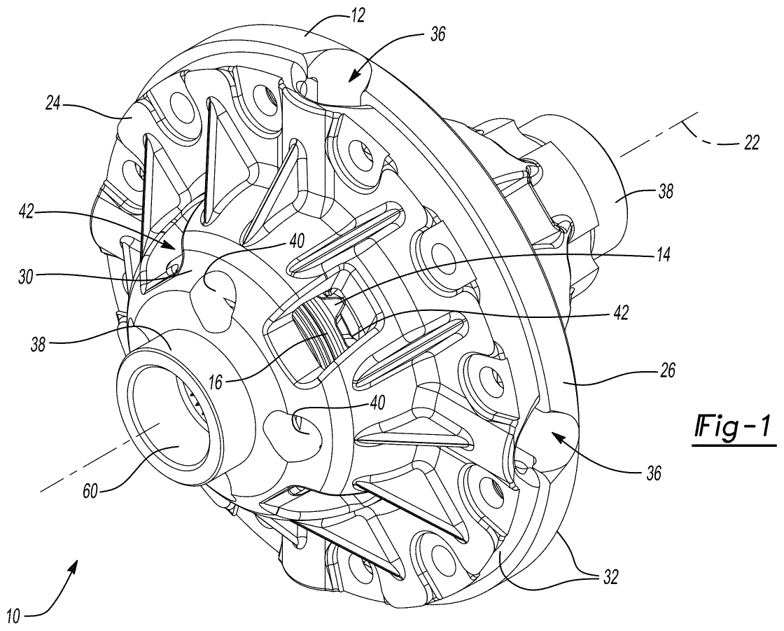

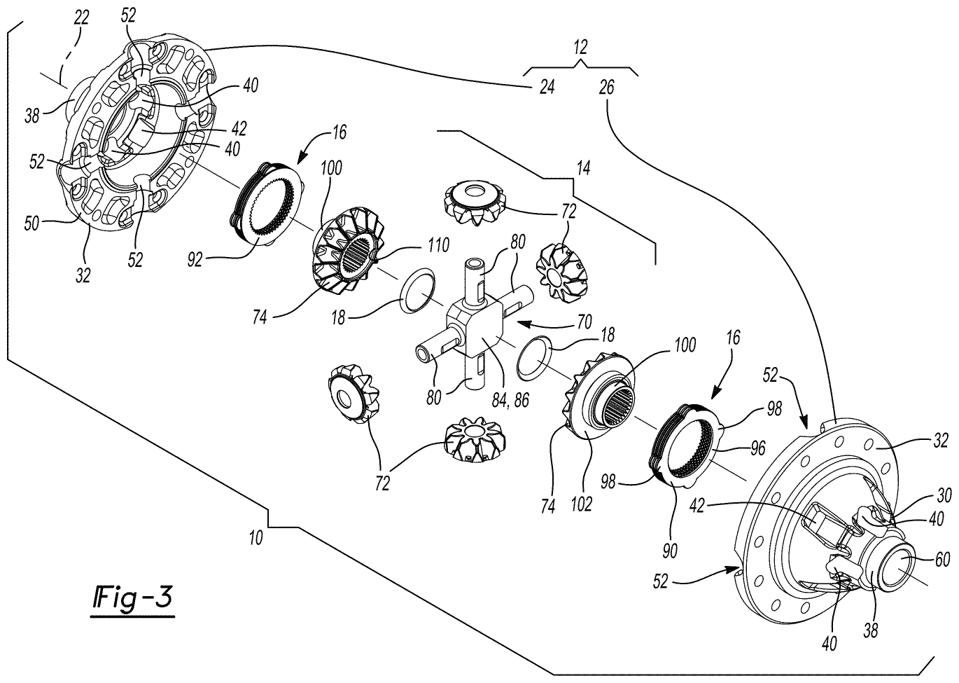

With reference to FIGS. 1 through 3, an exemplary differential assembly constructed in accordance with the teachings of the present disclosure is generally indicated by reference numeral 10. The differential assembly 10 can include a differential case 12, a differential gearset 14, one or two clutch packs 16, and a preload spring 18 for each clutch pack 16.

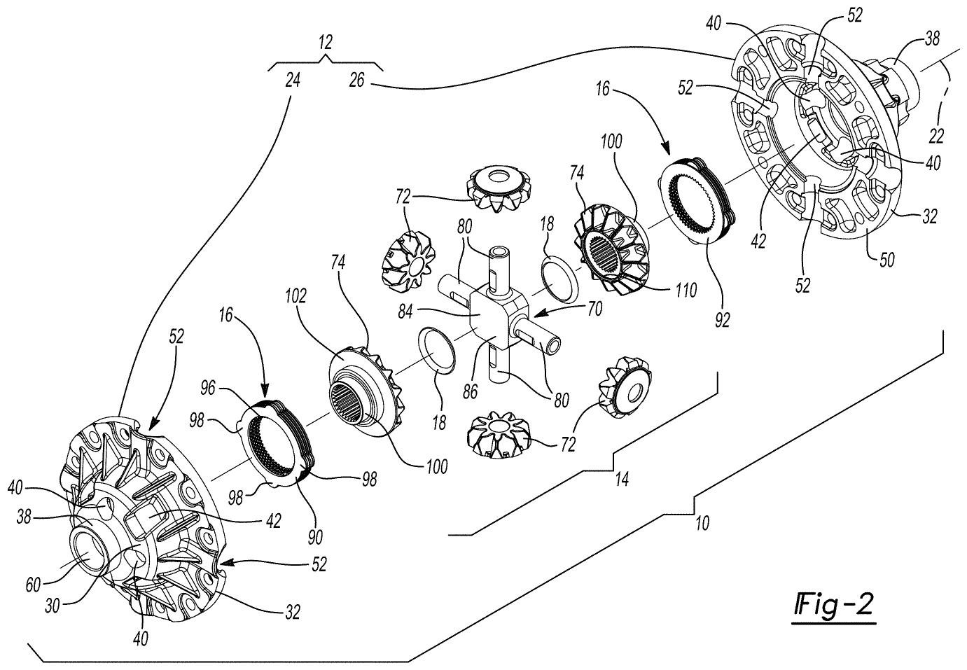

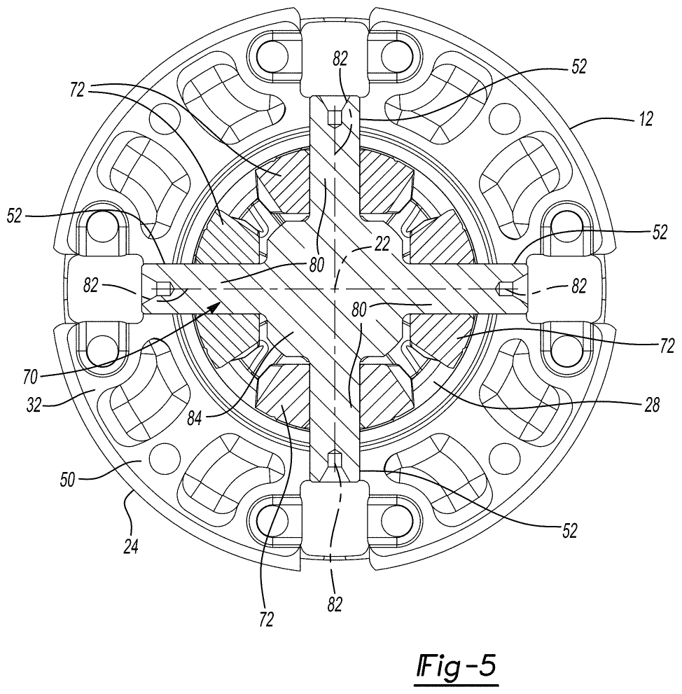

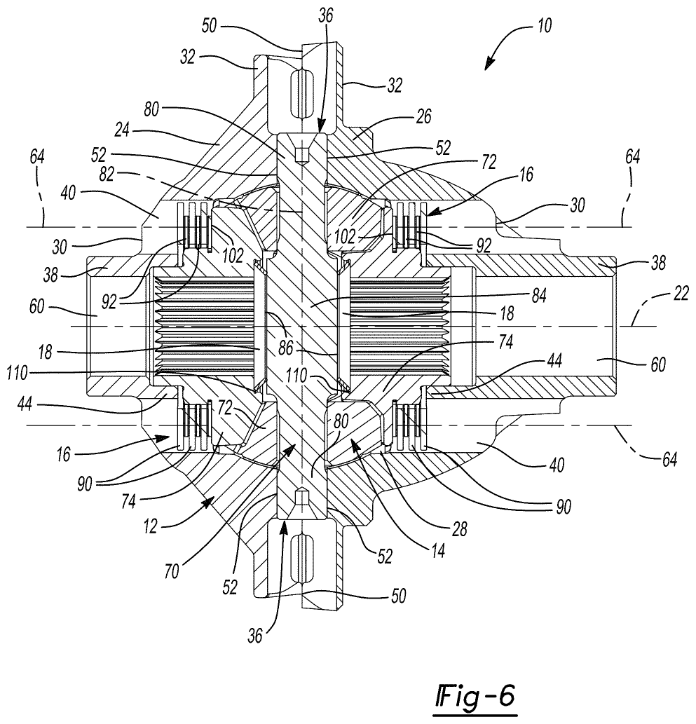

With reference to FIGS. 2, 3 and 6, the differential case 12 is rotatable about a differential axis 22 and can comprise a first case member 24 and a second case member 26 that cooperate to form a gearset cavity 28 into which the differential gearset 14, the clutch pack(s) 16 and the preload spring(s) 18 are received. Each of the first and second case members 24 and 26 can define a shoulder wall 30 and flange member 32, and may also optional define in whole or in part a plurality of pin bores 36, a pair of trunnions 38, a plurality of tab bores 40, and a plurality of lubrication apertures 42. The shoulder walls 30 have interior shoulder wall surfaces 44 that are disposed at the opposite lateral ends of the gearset cavity 28. The flange members 32 are configured to abut one another when the differential assembly 10 is assembled together. The pin bores 36 can be wholly formed in one of the first and second case members 24 and 26. In the example provided, however, portions of the pin bores 36 are formed in the flange members 32 of both of the first and second case members 24 and 26. More specifically, and as best shown in FIGS. 2, 3, 5 and 6, each of the flange members 32 has an abutting surface 50 that extends radially outwardly from the gearset cavity 28 and into which a plurality of pin recesses 52 are formed. Each of the pin recesses 52 can be shaped in a desired manner, such as a groove that is shaped as a longitudinal segment of a cylinder. When the first and second case members 24 and 26 are assembled together, the pin recesses 52 in the flange members 32 cooperate to form pin bores 36.

Returning to FIGS. 2, 3 and 6, the trunnions 38, if included, are configured to receive a differential bearing (not shown) thereon that is configured to support the differential case 12 relative to a housing (not shown) for rotation about the differential axis 22. Each of the trunnions 38 can extend axially from an associated one of the shoulder walls 30. A shaft bore 60 is formed through each of the trunnions 38 and is sized to receive an axle shaft (not shown) therethrough. Each shaft bore 60 intersects the gearset cavity 28. The tab bores 40 can be formed through one or both of the first and second case members 24 and 26 and are spaced circumferentially about the differential axis 22. Each of the tab bores 40 is disposed along a bore axis 64 that is parallel to but radially offset from the differential axis 22. The lubrication apertures 42 can optionally be formed in the first case member 24, the second case member 26 or both the first and second case members 24 and 26. The lubrication apertures 42 extend radially through the first case member 24 and/or the second case member 26 and intersect the gearset cavity 28.

With renewed reference to FIGS. 2, 3, 5 and 6, the differential gearset 14 is received in the gearset cavity 28 in the differential case 12 and can include one or more differential pinion shaft members 70, a plurality of differential pinions 72 and a pair of side gears 74. Each of the differential pinion shaft members 70 is mounted to the differential case 12 for rotation therewith about the differential axis 22 and has a pin 80 that supports an associated one of the differential pinions 72 for rotation about a differential pinion axis 82 that is perpendicular to the differential axis 22. In one form, the one or more differential pinion shaft members 70 can comprise two pins 80 that are unitarily and integrally formed and which support a pair of differential pinions 72. In the example shown, a quantity of four pins 80 are employed, with each of the pins 80 being disposed ninety degrees from an adjacent pair of the pins 80 and each pin 80 being received into a corresponding one of the pin bores 36 formed in the differential case 12. In this regard, each of the pins 80 is generally cylindrically-shaped and is received into a set of the pin recesses 52 in the flange members 32 of the first and second case members 24 and 26. One or more of the pins 80 can be fixedly coupled to the differential case 12 in any desired manner. For example, one or more roll pins (not shown), clips (not shown) or threaded fasteners (not shown) could be employed to fixedly couple one or more of the pins 80 to one or both of the first and second case members 24 and 26. The one or more differential pinion shaft members 70 can further comprise a central body 84 to which two or more of the pins 80 can be attached and extend radially outwardly from. In the example provided, the pins 80 and the central body 84 are integrally and unitarily formed and all of the pins 80 extend radially outwardly from the central body 84. The central body 84 can be shaped in any desired manner and can have generally flat axial end surfaces 86 that are oriented perpendicular to the differential axis 22.

Each of the differential pinions 72 is rotatably disposed on an associated one of the pins 80 radially inwardly from where the pins 80 are mounted to the differential case 12. Each of the pins 80 journally supports an associated differential pinion 72 for rotation relative to the differential case 12 about a respective differential pinion axis 82. It will be appreciated that the pins 80 also couple the differential pinions 72 for rotation with the differential case 12 about the differential axis 22. Each of the side gears 74 is meshingly engaged with the differential pinions 72 and is rotatable relative to the differential case 12 about the differential axis 22.

With reference to FIGS. 2, 3 and 6, a pair of clutch packs 16 and a pair of preload springs 18 are employed in the example shown to provide the differential assembly 10 with limited slip capabilities. It will be appreciated, however, that a single clutch pack 16 and a single preload spring 18 could be employed in the alternative.

Each clutch pack 16 can be disposed axially between the interior shoulder wall surfaces 44 of an associated one of the shoulder walls 30 and an associated one of the side gears 74 and can have a plurality of first clutch plates 90, which are axially-slidably but non-rotatably coupled to the differential case 12, and a plurality of second clutch plates 92 that are interleaved with the first clutch plates 90 and which are axially-slidably but non-rotatably coupled to the associated one of the side gears 74. For example, the first clutch plates 90 could be formed with a set of exterior teeth (not shown) formed on their outer circumference that engage with a set of interior teeth (not shown) formed on an inside surface of the differential case 12. In the particular example provided, the first clutch plates 90 have an annular body 96 and a plurality of semi-circular tabs 98 that are disposed about the circumference of the annular body 96 and extend radially outwardly therefrom. The tabs 98 are each sized to be received into a corresponding one of the tab bores 40 that are formed into the differential case 12. The second clutch plates 92 can have an annular shape and can be formed with a set of interior teeth (not specifically shown) formed on their inner circumferential surface that can mate with a set of external teeth 100 formed on the associated one of the side gears 74. The clutch pack 16 is confined between the interior shoulder wall surfaces 44 of the associated one of the annular shoulder walls 30 and an annular, radially extending abutment surface 102 formed on the associated one of the side gears 74.

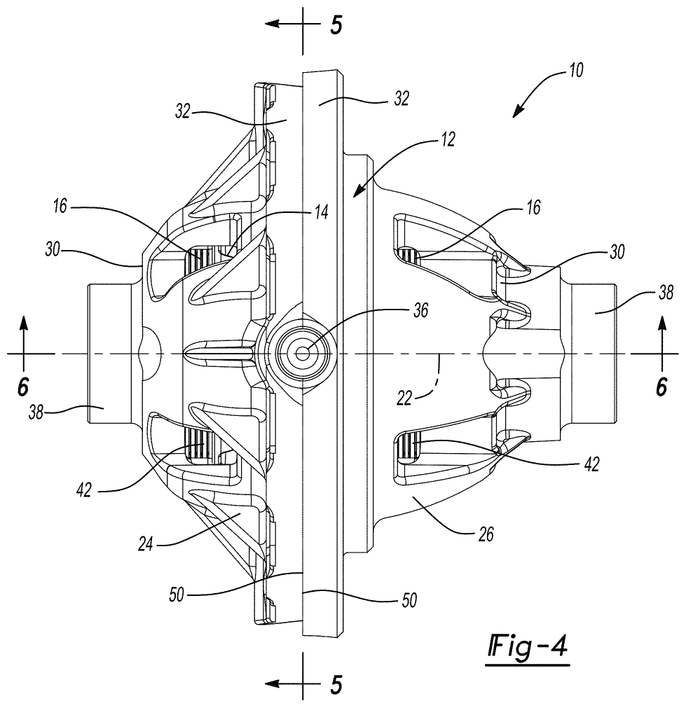

Returning to FIGS. 1 and 4, if lubrication apertures 42 are included in the differential case 12, the lubrication apertures 42 can be configured such that at least a portion of the clutch pack 16 is visible through the lubrication apertures 42. The lubrication apertures 42 can be configured to receive splash lubrication that is slung from a ring gear (not shown), which is non-rotatably coupled to the differential case 12, when the differential assembly 10 is in operation and/or to receive lubrication therethrough to lubricate the clutch packs 16 and the differential gearset 14 when the differential assembly 10 is at rest and lubrication enters the gearset cavity 28 through the lubrication apertures 42.

Returning to FIGS. 2, 3 and 6, each preload spring 18 is received axially (along the differential axis 22) between the one or more differential pinion shaft members 70 and a corresponding one of the side gears 74 and is configured to bias the corresponding one of the side gears 74 along the differential axis 22 away from the one or more of the differential pinion shaft members 70 to apply a preload to a corresponding one of the clutch packs 16. The preload springs 18 can be any type of spring or combination of springs, but in the example provided comprise Belleville spring washers that are received into counterbores 110 in the inward axial ends of the side gears 74 and abut the flat axial end surfaces 86 of the central body 84. While two or more Belleville spring washers could be employed to preload each of the clutch packs 16, it will be appreciated that a single Belleville spring washer can be employed to preload each of the clutch packs 16.

Optionally, one or more washer-like spacers or shims (not shown) can be employed between the interior shoulder wall surfaces 44 of the associated one of the shoulder walls 30 and the associated one of the clutch packs 16 to tailor the preload to a magnitude that is within desired limits. The spacers or shims could be non-rotatably coupled to the differential case 12 in a manner that is similar to that of the first clutch plates 90.

It will be appreciated that each preload spring 18 urges the corresponding side gear 74 along the differential axis 22 in a direction that tends to withdraw the corresponding side gear 74 from engagement with the differential pinions 72. It will further be appreciated that due to the bevel configuration of the differential pinions 72 and the side gears 74, the side gears 74 will be urged along the differential axis 22 away from the differential pinions 72 when relatively high torque is transmitted from the differential case 12 through the side gears 74. The clutch pack, however, significantly limits the distance with which the corresponding one of the side gears 74 is able to move along the differential axis, and is significantly less than in a prior art limited slip differential assembly having a preload spring that is disposed between an annular shoulder wall on the differential case and a clutch pack 16.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A differential assembly comprising:
a differential case that is rotatable about a differential axis;
a differential gearset received in the case, the differential gearset having a plurality of differential pinions, first and second side gears, and one or more differential pinion shaft members, each of the first and second side gears being rotatable about the differential axis relative to the differential case and being meshingly engaged with the differential pinions, the one or more differential pinion shaft members coupling the differential pinions to the differential case for common rotation about the differential axis, the one or more differential pinion shaft members supporting each of the differential pinions for rotation about a respective differential pinion axis that is perpendicular to the differential axis;
a first clutch pack received in the differential case, the first clutch pack having a plurality of first clutch plates, which are axially slidably but non-rotatably coupled to the differential case, and a plurality of second clutch plates that are interleaved with the first clutch plates and axially slidably but non-rotatably coupled to the first side gear; and
a first preload spring abutting the one or more differential pinion shaft members and the first side gear, the first preload spring biasing the first side gear away from the one or more differential pinion shaft members to preload the first clutch pack.

2. The differential assembly of claim 1, wherein a counterbore is formed in the first side gear and wherein the first preload spring is received into the counterbore.

3. The differential assembly of claim 2, wherein the first preload spring comprises a Belleville spring washer.

4. The differential assembly of claim 1, wherein the one or more differential pinion shaft members comprises a plurality of pins that extend from a central body, and wherein the first preload spring abuts the central body.

5. The differential assembly of claim 4, wherein the plurality of pins and the central body are unitarily and integrally formed with one another.

6. The differential assembly of claim 4, wherein the one or more differential pinion shaft members comprises four pins, each of the pins being disposed ninety degrees apart from each of an adjacent pair of the four pins.

7. The differential assembly of claim 4, wherein portion of the central body that contacts the first preload spring is flat.

8. The differential assembly of claim 1, wherein the differential case comprises first and second case members that are assembled together.

9. The differential assembly of claim 8, wherein each of the first and second case members is formed to matingly receive a respective portion of the one or more differential pinion shaft members that extends radially outwardly from the differential pinions.

10. The differential assembly of claim 8, wherein the first case member defines a plurality of lubrication apertures that are spaced circumferentially about the differential axis, each of the lubrication apertures extending radially through the first case member such that at least a portion of the first and second clutch plates are visible therethrough.

11. The differential assembly of claim 8, wherein a plurality of tab bores are formed axially through the first case member and spaced circumferentially about the differential axis, each of the tab bores being disposed along a bore axis that is parallel to but radially offset from the differential axis, wherein each of the first clutch plates has an annular body and a plurality of tabs, each of the tabs being received into a corresponding one of the tab bores.

12. The differential assembly of claim 1, further comprising a second clutch pack and a second preload spring, the second clutch pack having a plurality of third clutch plates, which are axially slidably but non-rotatably coupled to the differential case, and a plurality of fourth clutch plates that are interleaved with the third clutch plates and axially slidably but non-rotatably coupled to the second side gear, the second preload spring being disposed between the one or more differential pinion shaft members and the second side gear, the second preload spring biasing the second side gear away from the one or more differential pinion shaft members to preload the second clutch pack.

13. A differential assembly comprising:
a differential case that is rotatable about a differential axis, the differential case having first and second case members that each define a flange and an interior shoulder, each of the flanges defining a plurality of pin recesses, wherein the first and second case members are assembled to one another such that the flanges abut one another and the pin recesses form respective pin bores;
a plurality of pins received in the pin bores;
a plurality of differential pinions rotatably mounted on the plurality of pins;
a pair of side gears, each of the side gears being meshingly engaged to the differential pinions and being rotatable about the differential axis;
a pair of clutch packs, each of the clutch packs being disposed between an associated one of the shoulders and an associated one of the side gears and having a set of first clutch plates, which are axially slidably but non-rotatably coupled to the differential case, and a set of second clutch plates that are interleaved with the first clutch plates and which are axially slidably but non-rotatably coupled to the associated one of the side gears; and
a pair of preload springs, each of the preload springs being mounted on a corresponding one of the side gears and comprising a Belleville spring washer that is disposed axially between the plurality of pins and the corresponding one of the side gears.

14. The differential assembly of claim 13, wherein a counterbore is formed in each of the side gears and wherein each of the preload springs is received into the counterbore in the corresponding one of the side gears.

15. The differential assembly of claim 12, wherein the preload springs comprise one or more Belleville spring washers.

16. The differential assembly of claim 13, wherein the plurality of pins are attached to a central body, and wherein the preload springs abut the central body.

17. The differential assembly of claim 16, wherein the plurality of pins and the central body are unitarily and integrally formed with one another.
